(19) United States
(12) Patent Application Publication
(10) Pub. No.: US 2020/0216315 A1
(43) Pub. Date: Jul. 9, 2020

(54) Oxygen to Ozone Nanobubbles

(71) Applicant: Nano Gas Technologies, Inc., Deerfield, IL (US)

(72) Inventors: Jeffrey K Hardin, Wilmette, IL (US); Scott A Fiedler, Palatine, IL (US); Cliffton L Roe, Harrison Township, MI (US)

(21) Appl. No.: 16/733,708

(22) Filed: Jan. 3, 2020

Related U.S. Application Data
(60) Provisional application No. 62/788,425, filed on Jan. 4, 2019.

(51) Int. Cl. C01B 13/10; B01J 19/12

(52) U.S. Cl. CPC C01B 13/10; B01J 19/123

(57) ABSTRACT

A process includes converting dioxygen in oxygen nanobubbles to ozone by exposure of the dioxygen to UV light in a UV reactor.

### CROSS REFERENCE TO RELATED APPLICATIONS

This application claims priority to U.S. provisional patent application No. 62/788,425, filed Jan. 4, 2019, which is incorporated herein by reference.

### FIELD OF THE INVENTION

This disclosure is directed to the formation and use of ozone in nanobubble containing water.

### BACKGROUND

When ozone is produced it will decay rapidly, because ozone is an instable compound with a relatively short half-life. The half-life of ozone in water is a lot shorter than in air (see table 1). Ozone decays in water under drinking water conditions (pH: 6-8.5), partly in reactive OH-radicals. Therefore, the assessment of an ozone process always involves the reactions of two species: ozone and OH-radicals. When these OH-radicals are in the dominant particles in the solution, it is called an advanced oxidation process (AOP). The decay of ozone in OH-radicals in natural waters is characterized by a fast initial decrease of ozone, followed by a second phase in which ozone decreases by first order kinetics. Dependent on the quality of the water, the half-life of ozone is in the range of seconds to hours. Factors influencing the decomposition of ozone in water are temperature, pH, environment and concentrations of dissolved matter and UV light. Here, the main influence factors for ozone decomposition will be discussed.

Temperature: Temperature has an important influence on the half-life of ozone. Table 1 shows the half-life of ozone in air and water. In water the half-life of ozone is much shorter than in air, in other words ozone decomposes faster in water. The solubility of ozone decreases at higher temperatures and is less stable. On the other hand, the reaction speed increases with a factor 2 or 3 per 1020 C. Principally, ozone dissolved in water cannot be applied when temperatures are above 40° C., because at this temperature the half-life of ozone is very short.

TABLE 1
half-life of ozone in gas and water at different temperatures

| AIR | | | Water pH 7 | | |
|---|---|---|---|---|---|
| Temp (° C.) | Half live | | Temp (° C.) | Half live | |
| −50 | 3 | months | 15 | 30 | min |
| −35 | 18 | days | 20 | 20 | min |
| −25 | 8 | days | 25 | 15 | min |
| 20 | 3 | days | 30 | 12 | min |
| 120 | 1.5 | hours | 35 | 8 | min |
| 250 | 1.5 | seconds | | | |

pH: As mentioned above, ozone decomposes partly in OH-radicals. When the pH value increases, the formation of OH-radicals increases. In a solution with a high pH value, there are more hydroxide ions present, see formulas below. These hydroxide ions act as an initiator for the decay of ozone:

O₃+OH⁻→HO₂⁻+O₂

2O₃+HO₂⁻→.OH+O₂^{.-}=O₂

The radicals that are produced during reaction 2 can introduce other reactions with ozone, causing more OH-radicals to be formed.

In addition the pH influences acid/base equilibriums of some compounds and also the reaction speed of ozone. This applies also to the reaction with scavenger CO₃²⁻, which is also pH dependent (pKa HCO₃²⁻/CO₃²⁻=10.3).

FIG. 1 shows that the decay of ozone in a basic environment (e.g., with a pH of 10.4) is much faster than in an acidic environment (e.g., with a pH of 7.6).

Dissolved solids concentration: Dissolved ozone can react with a variety of matter, such as organic compounds, viruses, bacteria, etc. As a result, ozone decomposes to other matter; see FIG. 2. FIG. 2 illustrates the decomposition of ozone in different types of water at 20° C. In particular, FIG. 2 compares the decomposition of ozone in double-distilled water 1; distilled water 2; tap water 3; groundwater of low hardness 4; filtered water from Lake Zurich (Switzerland) 5; and filtered water from the Bodensee (Switzerland) 6. As depicted, the half-life of ozone in distilled water is much shorter compared to tap-water.

Ozone decomposes in water in OH-radicals. Dependent on the nature of the dissolved matter, these can accelerate (chain-reaction) or slow down the decay of ozone. Substances that accelerate this reaction are called promoters. Inhibitors are substances that slow down the reaction.

When water is ozonized, one often uses the term ‘scavenging capacity’. Scavengers are entities that react with OH-radicals and slow down the chain-reaction.

Carbonate and bicarbonate: Scavengers slow down the chain-reaction. This is because after the reaction of scavengers with OH-radicals, the reaction products do not react with ozone any further. Carbonate is a scavenger with a strong effect. The addition of carbonate (CO₃²⁻) can increase the half-life of ozone. The effect on the reaction speed is highest at low concentrations. Above 2 mmol⁻¹ for ozonation and 3 mmol l⁻¹ for advanced oxidation process (AOP), the decrease in the reaction speed is negligible.

When a solution mainly undergoes indirect reactions (with OH-radicals), for instance in a solution with a high pH value or an AOP-process, the presence of scavengers is undesired. The scavengers react very fast with OH-radicals and lower the oxidation capacity. For this kind of processes, a low scavenging capacity is required.

Carbonate (CO₃²⁻) ions are a much stronger scavengers than bicarbonate

(HCO₃²⁻) ions (reaction speed CO₃²⁻:k =4.2*10⁸M⁻¹s⁻¹ and reaction speed HCO₃⁻:k =1.5*10⁷ M⁻¹s⁻¹). That is why in an ozone process under drinking water conditions, the bicarbonate concentration is less important. FIG. 3 illustrates the relationship between the carbonate ratio, bicarbonate ratio and pH.

Natural Organic Material: Natural organic material (NOM) exists in every kind of natural water and is often measured as dissolved organic carbon (DOC). NOM reduces the quality of the water with regard to color and odor. Ozone can be used in water treatment, for the reduction of the concentration of NOM. The concentration of NOM in natural waters can vary from 0.2-10 mg l⁻¹. The influence of NOM on ozone is twofold. Dependent on the type of NOM, it can be oxidized directly by NOM. This is the case for compounds which easily react with ozone, such as double bonds, activated aromatic compounds, deprotonated amines and sulfide. On the other hand, OH-radicals can react with NOM (indirect reaction) and act as a promoter or as a scavenger.

In natural waters, it is difficult to determine the stability of ozone as a result of the indefinite effect of NOM. That means it is not possible to estimate the fraction that accelerates or slows down the reaction.

### SUMMARY

A first embodiment is a process that includes converting dioxygen in oxygen nanobubbles to ozone by exposure of the dioxygen to UV light in a UV reactor.

A second embodiment is a system that includes an oxygen source selected from a gas storage apparatus or an oxygen concentrator; the oxygen source fluidly connected to an oxygen input on a nanobubble production apparatus that includes a water input, the oxygen input, and an oxygen nanobubble solution output; the oxygen nanobubble solution output fluidly connected to a UV reactor that includes an oxygen nanobubble solution input, a UV source optically connected to a nanobubble solution pathway, and an ozone nanobubble solution output.

### BRIEF DESCRIPTION OF THE FIGURES

For a more complete understanding of the disclosure, reference should be made to the following detailed description and accompanying drawing figures wherein:

FIG. 1 illustrates the effect of pH on the decay of ozone at 15° C.;

FIG. 2 depicts ozone decomposition in different types of water at 20° C.; and

FIG. 3 illustrates the relationship between the carbonate ratio, the bicarbonate ratio and pH.

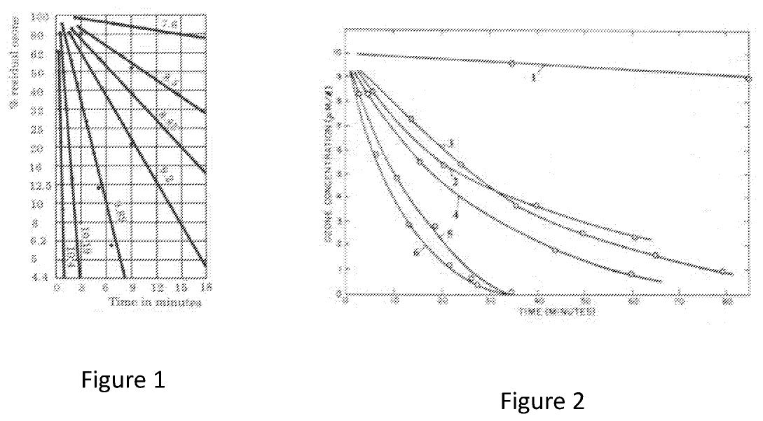

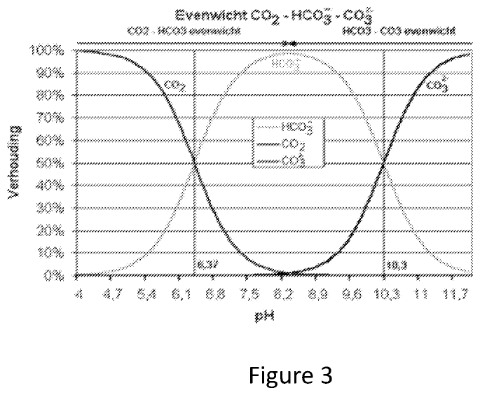

While specific embodiments are illustrated in the figures, with the understanding that the disclosure is intended to be illustrative, these embodiments are not intended to limit the invention described and illustrated herein.

### DETAILED DESCRIPTION

Objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

Herein, the use of the word “a” or “an” when used in conjunction with the term “comprising” in the claims and/or the specification may mean “one,” but it is also consistent with the meaning of “one or more,” “at least one,” and “one or more than one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

One embodiment is a process of converting dioxygen in oxygen nanobubbles to ozone by exposure of the dioxygen to UV light in a UV reactor. More specifically, the process includes converting dioxygen (O₂) that is in the gas phase within oxygen nanobubbles carried within an oxygen nanobubble solution into ozone (O₃) by UV light, pursuant to the following equation:

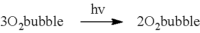

An oxygen nanobubble solution can include, consist essentially of, or consist of oxygen nanobubbles in a solvent, preferably water. More preferably, the oxygen nanobubble solution consists essentially of oxygen nanobubbles in water. The oxygen nanobubbles include greater than 22% O₂, preferably greater than 32% O₂, more preferably greater than 50% O₂, even more preferably greater than 75% O₂, and still more preferably greater than 90% O₂. Herein, gas percentages are mass percentages. While the oxygen nanobubble (in the oxygen nanobubble solution) can include other gases (typically nitrogen gas), the oxygen nanobubble preferably is free of ozone or is substantially free of ozone, herein substantially free means the nanobubble includes less than 5%, 4%, 3%, 2%, 1% or 0.5% ozone; preferably the ozone concentration in the nanobubble is less than 0.1 ppm. In another instance, the oxygen nanobubble solution can include an admixture of oxygen nanobubbles and nitrogen nanobubbles and/or nanobubbles that include both oxygen and nitrogen.

Herein, the nanobubble solution is preferably free of macrobubbles. That is, the nanobubble solution is a homogeneous solution of nanobubbles and the solvent, wherein the solution does not include bubbles that rise to a surface. The term “nanobubbles” means bubbles of a gas within a liquid, wherein the bubbles having an average diameter of about 10 nm to about 400 nm, about 10 nm to about 300 nm, about 10 nm to about 250 nm, about 10 nm to about 200 nm, about 10 nm to about 150 nm, or about 10 nm to about 100 nm. The herein utilized nanobubbles can be formed in or by a nanogas solution generator, one example of which is provided in U.S. Pat. No.9,586,176 which is incorporated herein in its entirety.

The nanogas solution or nanobubble solution is preferably homogeneous, that is, the nanobubbles are evenly distributed throughout the solution and appear as a suspended “particulate” in the liquid. Notably, the liquid may further be saturated with or near saturation with the gas that comprises the nanobubbles. A mixture of bubbles and liquid wherein the bubbles coalesce and/or rise to the surface and break is not a homogeneous mixture of nanobubbles and the liquid.

Preferably, the process includes exposing the oxygen in the oxygen nanobubbles to UV light having a wavelength between about 160 nm to 240 nm; more preferably, the UV light has a wavelength between about 175 nm and 210 nm. Even more preferably, the UV light is provided by a 185 nm UV lamp.

The process can further include providing the oxygen nanobubble solution to the UV reactor wherein the oxygen nanobubble solution is exposed to the UV light. In one instance, the oxygen nanobubble solution can be provided by conveying a pressurized admixture of oxygen and water to a nozzle and converting the pressurized admixture to the oxygen nanobubble solution via the nozzle; thereafter exposing the oxygen nanobubble solution to the UV light.

Another embodiment is a process that includes providing an oxygen nanobubble solution to a UV reactor, converting dioxygen in the oxygen nanobubbles to ozone, and then diffusing ozone from the nanobubbles into the water, for example by the following reaction equation:

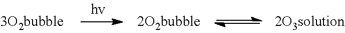

Preferably, the provided oxygen nanobubble solution consists essentially of a plurality of oxygen nanobubbles in water. The solution having a dissolved dioxygen concentration and a dissolved ozone concentration; the oxygen nanobubbles consisting essentially of dioxygen. Preferably, the dioxygen in the oxygen nanobubbles is converted to ozone in the nanobubble while not affecting the dissolved dioxygen concentration or the dissolved ozone concentration, thereby an ozone nanobubble solution is formed. Thereafter the ozone is diffused from the nanobubble into the water. That is, the provided oxygen nanobubble solution is irradiated with UV light of sufficient wavelength (preferably about 185 nm) and intensity to convert greater than about 5%, 10%, 15%, 20%, 25%, 30%, 35%, 40%, 45%, or 50% of the dioxygen in any nanobubble into ozone, the ozone in the nanobubble is then diffused into the water increasing the dissolved ozone concentration. In one instance, the provided oxygen nanobubble solution has a dissolved dioxygen concentration that is greater than 5 ppm, greater than 7.5 ppm, greater than 10 ppm, greater than 12.5 ppm, greater than 15 ppm, or greater than 20 ppm. Preferably, the provided oxygen nanobubble solution is saturated with dissolved dioxygen.

In another instance, the provided oxygen nanobubble solution has a dissolved ozone concentration which is less than 1 ppm, less than 0.9 ppm, less than 0.8 ppm, less than 0.7 ppm, less than 0.6 ppm, less than 0.5 ppm, less than 0.4 ppm, less than 0.3 ppm, less than 0.2 ppm, or less than 0.1 ppm. More preferably, the provided oxygen nanobubble solution is substantially free of, or free of ozone; e.g., having a dissolved ozone concentration less than 0.05 or 0.01 ppm.

In yet another instance, as the ozone diffuses into the water dioxygen from the water diffuses into the nanobubbles. For example, the process can include a diffusion equilibrium between the water and the nanobubbles, preferably wherein the diffusion equilibrium includes ozone moving from the nanobubble into the water and dioxygen moving from the water into the nanobubble. Notably, and importantly, the diffusion of ozone from the nanobubbles into the water increases the dissolved ozone concentration. In one instance, the dissolved ozone concentration increases at a rate of at least about 0.05 ppm/hour, 0.1 ppm/hour, 0.15 ppm/hour, 0.2 ppm/hour, 0.25 ppm/hour, 0.3 ppm/hour, 0.35 ppm/hour, 0.4 ppm/hour, 0.45 ppm/hour, or 0.5 ppm/hour. Notably and as described in the Background, ozone dissolved in water has a half-life of about 20 min at 20° C., therefore for the dissolved ozone concentration to increase, the rate of diffusion of ozone from the bubble into the water needs to be greater than the rate of decomposition. In one instance, this rate of diffusion of ozone from the nanobubble into the water that is greater than a sum of a rate of diffusion of dissolved ozone into the nanobubble plus a rate of decomposition of dissolved ozone in water.

In another instance, the process can include reacting dissolved ozone with a contaminant, and further diffusing ozone from the nanobubbles into the water. The contaminant can be any agent that is oxidized by ozone, examples include single cell organisms, biomaterials, organic compounds, sulfur containing compounds (soluble and dispersed), and the like. In one example the contaminant is a single cell organism. When, for example, the contaminant is a single cell organism (e.g., yeast or bacteria), the process can further include admixing the ozone nanobubble solution with a biofilm solvent (e.g., limonene) prior to contacting the ozone nanobubble solution with the single cell organism. In one instance, the biofilm solvent exposes the single cell organism to the solution and thereby the ozone and therefore increases a rate of reaction of the ozone with the single cell organism. In still another instance, the contaminant is a sulfur containing compound. When the contaminant is a sulfur containing compound (e.g., a thiol, a thio-ether, a sulfide (e.g., iron sulfide, copper sulfide), a sulfonate), the process includes the oxidation of the sulfur and the formation of sulfur-oxides, e.g., sulfones, sulfonates, and sulfates.

Herein, the process of forming the ozone nanobubbles, preferably, does not affect the concentration (number of bubbles per unit volume) of the nanobubbles. In one instance, the oxygen nanobubble solution includes a concentration of oxygen nanobubbles; and wherein the ozone nanobubble solution includes a concentration of ozone nanobubbles that is approximately equal to the concentration of oxygen nanobubbles. The concentration of nanobubbles (of any type) can be measured by diffraction. As the process preferably does not affect the nanobubble concentration, the diffusion of ozone from a nanobubble into the water and/or the diffusion of oxygen from the water into a nanobubble, preferably, does not affect the concentration of nanobubbles.

Another embodiment is a system that can include an oxygen source selected from a gas storage apparatus or an oxygen concentrator; where the oxygen source is fluidly connected an oxygen input on a nanobubble production apparatus that includes a water input, the oxygen input, and an oxygen nanobubble solution output; and where the oxygen nanobubble solution output fluidly connected to a UV reactor that includes an oxygen nanobubble solution input, a UV source optically connected to a nanobubble solution pathway, and an ozone nanobubble solution output.

While the compositions and methods of this invention have been described in terms of preferred embodiments, it will be apparent to those of skill in the art that variations may be applied to the compositions and/or methods in the steps or in the sequence of steps of the method described herein without departing from the concept, spirit and scope of the invention. More specifically, it will be apparent that certain agents that are both chemically and physically related may be substituted for the agents described herein while the same or similar results would be achieved. All such similar substitutes and modifications apparent to those skilled in the art are deemed to be within the spirit, scope and concept of the invention as defined by the appended claims.

What is claimed:

1. A process comprising:
converting dioxygen in oxygen nanobubbles to ozone by exposure of the dioxygen to UV light in a UV reactor.

2. The process of claim 1, wherein converting dioxygen to ozone includes exposing an oxygen nanobubble solution that includes a plurality of oxygen nanobubbles in water to UV light, where the oxygen nanobubbles consist essentially of dioxygen and have an ozone concentration less than 0.1 ppm.

3. The process of claim 2, wherein the oxygen nanobubble solution is free of macrobubbles.

4. The process of claim 2, wherein the oxygen nanobubble solution comprises an admixture of oxygen nanobubbles and nitrogen nanobubbles.

5. The process of claim 1, wherein the UV light has a wavelength between about 160 nm to 240 nm.

6. The process of claim 5, wherein the UV light has a wavelength between about 175 nm and 210 nm.

7. The process of claim 5, wherein the UV light is provided by a 185 nm UV lamp.

8. The process of claim 1 further comprising providing the oxygen nanobubble solution to the UV reactor wherein the oxygen nanobubble solution is exposed to the UV light.

9. The process of claim 8 further comprising providing the oxygen nanobubble solution by conveying a pressurized admixture of oxygen and water to a nozzle and converting the pressurized admixture to the oxygen nanobubble solution via the nozzle; thereafter exposing the oxygen nanobubble solution to the UV light.

10. A process comprising:
providing an oxygen nanobubble solution to a UV reactor, the provided oxygen nanobubble solution consisting essentially of a plurality of oxygen nanobubbles in water, wherein the solution has a dissolved dioxygen concentration and a dissolved ozone concentration; and wherein the oxygen nanobubbles consisting essentially of dioxygen; therein
converting dioxygen in the oxygen nanobubbles to ozone while not affecting the dissolved dioxygen concentration or the dissolved ozone concentration, thereby forming an ozone nanobubble solution; and thereafter
diffusing ozone from the nanobubbles into the water.

11. The process of claim 10, wherein the provided oxygen nanobubble solution has a dissolved dioxygen concentration that is greater than 5 ppm, and a dissolved ozone concentration is less than 1 ppm.

12. The process of claim 11, wherein the provided oxygen nanobubble solution is saturated with dissolved dioxygen.

13. The process of claim 11, wherein the dissolved ozone concentration of the provided oxygen nanobubble solution is less than 0.5 ppm.

14. The process of claim 10 further comprising diffusing dioxygen from the water into the nanobubbles.

15. The process of claim 10 further comprising a diffusion equilibrium between the water and the nanobubbles.

16. The process of claim 10 wherein diffusing ozone from the nanobubbles into the water increases the dissolved ozone concentration.

17. The process of claim 16, wherein the dissolved ozone concentration increases at a rate of at least 0.1 ppm/hour.

18. The process of claim 16, wherein a rate of diffusion of ozone from the nanobubble into the water that is greater than a sum of a rate of diffusion of dissolved ozone into the nanobubble plus a rate of decomposition of dissolved ozone in water.

19. The process of claim 10 further comprising reacting dissolved ozone with a contaminant, and further diffusing ozone from the nanobubbles into the water.

20. The process of claim 19, wherein the contaminant is a single cell organism.

21. The process of claim 20 further comprising admixing the ozone nanobubble solution with a biofilm solvent (e.g., limonene) prior to contacting the ozone nanobubble solution with the single cell organism.

22. The process of claim 19, wherein the contaminant is a sulfur containing compound.

23. The process of claim 10, wherein the oxygen nanobubble solution includes a concentration of oxygen nanobubbles; and wherein the ozone nanobubble solution includes a concentration of ozone nanobubbles that is approximately equal to the concentration of oxygen nanobubbles.

24. The process of claim 23, wherein the diffusion of ozone from a nanobubble into the water and/or the diffusion of oxygen from the water into a nanobubble does not affect the concentration of nanobubbles.

25. A system comprising:
an oxygen source selected from a gas storage apparatus or an oxygen concentrator;
the oxygen source fluidly connected to an oxygen input on a nanobubble production apparatus that includes a water input, the oxygen input, and an oxygen nanobubble solution output;
the oxygen nanobubble solution output fluidly connected to a UV reactor that includes an oxygen nanobubble solution input, a UV source optically connected to a nanobubble solution pathway, and an ozone nanobubble solution output.
